(19) United States
(12) Patent Application Publication
(10) Pub. No.: US 2021/0107684 A1
(43) Pub. Date: Apr. 15, 2021

(54) MODULAR AUTONOMOUS AIRCRAFT CONTROL AND RESUPPLY STATION

(71) Applicant: Olivier Le Lann, Lisbon (PT)

(72) Inventor: Olivier Le Lann, Lisbon (PT)

(21) Appl. No.: 17/070,834

(22) Filed: Oct. 14, 2020

Related U.S. Application Data
(60) Provisional application No. 62/914,860, filed on Oct. 14, 2019.

(51) Int. Cl. B64F 1/36; B64F 1/22; B64F 1/26; B64F 1/28; B64F 1/32; B60L 53/10; B60L 53/30; B60L 53/50; B60L 53/68; G05D 1/00; B65D 88/12; B65D 90/00

(52) U.S. Cl. CPC B64F 1/362; B64F 1/222; B64F 1/26; B64F 1/28; B64F 1/32; B60L 53/10; B60L 2200/10; B60L 53/50; B60L 53/68; G05D 1/0016; B65D 88/121; B65D 90/0073; B60L 53/305

(57) ABSTRACT

Disclosed is a modular autonomous aircraft control and resupply station. The modular autonomous aircraft control and resupply station may include an enclosure comprising a rigid outer shell configured to enclose each component of the modular autonomous aircraft control and resupply station. Further, the modular autonomous aircraft control and resupply station may include a communication system configured to communicate with at least one of a vehicle and a remote system, a command console configured to provide a user interface to an operator, an internal resource bunker configured to house a plurality of redistributable materials to be transferred onto and received from the vehicle, a landing carousel configured to maneuver the vehicle and a power source configured to provide electrical power to operate one or more components of the modular autonomous aircraft control and resupply station.

The current application claims a priority to the U.S. Provisional Patent application Ser. No. 62/914,860 filed on Jan. 1, 2014.

### FIELD OF THE INVENTION

Generally, the present disclosure relates to the field of self-guided avionics and fleet management. More specifically, the present disclosure relates to modular autonomous aircraft control and resupply stations.

### BACKGROUND OF THE INVENTION

In present times conventional logistic networks employ multimodal transportation, wherein cargo is transported by ship, rail, freight hauler, and eventually individual delivery vehicles to maximize the value of bulk-handling and minimize the distance traveled for final deliveries. This system currently represents the most effective means for effecting delivery of a package from a bulk source (i.e. a manufacturer or producer) to any given customer.

However, with the advent of economical remote aircraft (colloquially recognized as drones, regardless of capacity for autonomous flight) new avenues of operation are available that may have previously been infeasible or even impossible given a lack of precisions guidance. Initiatives are currently underway in the market by some companies, and others to integrate the capacity for airborne vehicles to deliver packages into their current logistics networks. This represents a multitude of benefits to a private company, including reduced labor-hours for ‘last-mile’ delivery drivers, a reduction in fuel and maintenance costs, and a capacity for faster, more direct delivery based on modern pathfinding and positioning systems. The general public may additionally enjoy a reduction in logistical traffic, including large cargo trucks and delivery vans and a corresponding reduction in pollution or road-wear generally associated with commercial vehicles.

However, the implementation of autonomous airborne vehicles fails to provide a means for long-range deliveries, often limiting a serviceable area to a zone around a permanent fleet management hub. This shortcoming is more severe in applications such as search-and-rescue, disaster management, and the transport of critical cargo to remote locations—there simply is not anywhere for the vehicles to refuel or refit.

Therefore, there is a need for improved modular autonomous aircraft control and resupply stations that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed is a modular autonomous aircraft control and resupply station. The modular autonomous aircraft control and resupply station may include an enclosure comprising a rigid outer shell configured to enclose each component of the modular autonomous aircraft control and resupply station. Further, the modular autonomous aircraft control and resupply station may include a communication system configured to communicate with at least one of a vehicle and a remote system. Further, the modular autonomous aircraft control and resupply station may include a command console configured to provide a user interface to an operator. Further, the user interface may include a display device configured to display operational data associated with at least one of modular autonomous aircraft control and resupply station and a vehicle associated therewith and an input device configured to receive a command from the operator. Further, the modular autonomous aircraft control and resupply station may include an internal resource bunker configured to house a plurality of redistributable materials to be transferred onto and received from the vehicle. Further, the modular autonomous aircraft control and resupply station may include a landing carousel configured to maneuver the vehicle. Further, the modular autonomous aircraft control and resupply station may include a power source configured to provide electrical power to operate one or more components of the modular autonomous aircraft control and resupply station.

According to some embodiments, a modular autonomous aircraft control and resupply station is disclosed. The modular autonomous aircraft control and resupply station may include an enclosure comprising a rigid outer shell configured to enclose each component of the modular autonomous aircraft control and resupply station. Further, the enclosure may include at least one external mount configured to fix the enclosure to a freight-handling machinery and further configured to link the enclosure to a second enclosure of a second modular autonomous aircraft control and resupply station configured to extend at least one functionality of the modular autonomous aircraft control and resupply station. Further, the modular autonomous aircraft control and resupply station may include a communication system configured to communicate with at least one of a vehicle of a managed fleet of vehicles and a remote system. Further, the modular autonomous aircraft control and resupply station may include a command console configured to provide a user interface to an operator. Further, the user interface may include a display device configured to display operational data associated with at least one of modular autonomous aircraft control and resupply station and a vehicle associated therewith and an input device configured to receive a command from the operator. Further, the command console may be configured to autonomously monitor and guide a plurality of operations of a managed fleet of vehicles associated with the modular autonomous aircraft control and resupply station. Further, the modular autonomous aircraft control and resupply station may include an internal resource bunker configured to house a plurality of redistributable materials to be transferred onto and received from a vehicle. Further, the modular autonomous aircraft control and resupply station may include a landing carousel configured to maneuver the vehicle. Further, the modular autonomous aircraft control and resupply station may include a power source configured to provide electrical power to operate one or more components of the modular autonomous aircraft control and resupply station.

According to some embodiments, a modular autonomous aircraft control and resupply station is disclosed. Further, the modular autonomous aircraft control and resupply station may include an enclosure comprising a rigid outer shell configured to enclose each component of the modular autonomous aircraft control and resupply station. Further, the enclosure may include at least one external mount configured to fix the enclosure to a freight-handling machinery and further configured to link the enclosure to a second enclosure of a second modular autonomous aircraft control and resupply station configured to extend at least one functionality of the modular autonomous aircraft control and resupply station. Further, the modular autonomous aircraft control and resupply station may include a communication system configured to communicate with at least one of a vehicle of a managed fleet of vehicles and a remote system. Further, the modular autonomous aircraft control and resupply station may include a command console configured to provide a user interface to an operator. Further, the user interface may include a display device configured to display operational data associated with at least one of modular autonomous aircraft control and resupply station and a vehicle associated therewith and an input device configured to receive a command from the operator. Further, the command console may be configured to autonomously monitor and guide a plurality of operations of a managed fleet of vehicles associated with the modular autonomous aircraft control and resupply station. Further, the modular autonomous aircraft control and resupply station may include an internal resource bunker configured to house a plurality of redistributable materials to be transferred onto and received from a vehicle. Further, the modular autonomous aircraft control and resupply station may include a landing carousel configured to maneuver the vehicle. Further, the landing carousel may include a plurality of disruption devices comprising an array of microphones configured to capture a vehicle sound generated by the vehicle during at least one of take-off and landing. Further, the array of microphones may be communicatively coupled to the command console. Further, the plurality of disruption devices may include an array of speakers communicatively coupled to the command console. Further, the array of speakers may be configured to generate sound. Further, the command console may include a processor configured to generate a negative vehicle sound configured to cancel the vehicle sound when reproduced through the array of speakers. Further, the modular autonomous aircraft control and resupply station may include a power source configured to provide electrical power to operate one or more components of the modular autonomous aircraft control and resupply station.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front top left side perspective view of a modular autonomous aircraft control and resupply station, in accordance with some embodiments.

FIG. 2 is a front view of the modular autonomous aircraft control and resupply station, in accordance with some embodiments.

FIG. 3 is a cross-section view of the modular autonomous aircraft control and resupply station along line 1-1 of FIG. 2, in accordance with some embodiments.

FIG. 4 is a top view of the modular autonomous aircraft control and resupply station, in accordance with some embodiments.

FIG. 5 is a left side view of the modular autonomous aircraft control and resupply station, in accordance with some embodiments.

FIG. 6 is a rear view of the modular autonomous aircraft control and resupply station, in accordance with some embodiments.

FIG. 7 is a front top right side perspective view of a landing carousel, in accordance with some embodiments.

FIG. 8 is a close-up perspective view of an area of FIG. 7, in accordance with some embodiments.

FIG. 9 is a schematic of an internal resource bunker, in accordance with some embodiments.

FIG. 10 is a front top left side perspective view of a modular autonomous aircraft control and resupply station, in accordance with some embodiments.

FIG. 11 is a front top right side perspective view of the modular autonomous aircraft control and resupply station.

FIG. 12 is a rear left side perspective view of the modular autonomous aircraft control and resupply station.

FIG. 13 is an illustration of an online platform consistent with various embodiments of the present disclosure.

FIG. 14 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of modular autonomous aircraft control and resupply stations, embodiments of the present disclosure are not limited to use only in this context.

Overview:

According to some embodiments, the present disclosure provides a modular command, control, and resupply station suitable for remote or off-grid deployment to support various aircraft, either individually or as a part of a broader network.

The present disclosure aims to provide a modular, deployable hub for the operation, service, and maintenance of a fleet airborne vehicles. Specific consideration is given to enable the present disclosure to be broken down into individual, self-contained, functional elements that may be easily transported by conventional means and methods to any location to serve individual nodes in a logistic network. Operating in conjunction, multiple instances of the present disclosure will provide a means for a vehicle of limited range to traverse extended distances with repeated stops for resupply en route. Further, the vehicles may land, be serviced, and take off without direct interaction with a human operator. All operable functions of the vehicles themselves may be supported by the present disclosure as a control relay as well as a resupply station, enabling remote control of any given vehicle from any given installation of the modular vertical take-off and landing station connected to a mesh network established by and between said installations.

According to some embodiments, a Vertical Station is disclosed, wherein the Vertical Station is a combination of a ground control station and landing/take-off, charging station for electric vertical take-off and landing aircraft.

It allows aircraft to land safely on a landing pad, then be stored automatically in the station and charged. An inner carousel system allows them to be stored on a filo (first in last out) basis.

Further, the station hosts on the other side a full ground control system allowing it to get the data from aircraft and send instructions.

Further, the station is powered through electricity but hosts a power station (such as Powerwall™) to be self-sufficient during electricity outages.

It is modular and while its main base is 20 feet high cube container to allow it to be sent through a boat to many locations, it can be up to 40 feet allowing more storage or bundled with other stations.

Further, the dispatch of stations may create a mesh which enable the creation of a 3D mobility system for logistics, support or surveillance purpose.

The stations may also be equipped of dynamic noise cancelling speakers to remove the landing noise.

According to some embodiments, a modular vertical take-off and landing station. The modular vertical take-off and landing station aims to provide a modular, deployable hub for the operation, service, and maintenance of a fleet airborne vehicles. Specific consideration is given to enable the modular vertical take-off and landing station to be broken down into individual, self-contained, functional elements that may be easily transported by conventional means and methods to any location to serve individual nodes in a logistic network. Operating in conjunction, multiple instances of the modular vertical take-off and landing station will provide a means for a vehicle of limited range to traverse extended distances with repeated stops for resupply en route. Further, the vehicles may land, be serviced, and take off without direct interaction with a human operator. All operable functions of the vehicles themselves may be supported by the modular vertical take-off and landing station as a control relay as well as a resupply station, enabling remote control of any given vehicle from any given installation of the modular vertical take-off and landing station connected to a mesh network established by and between said installations.

Further, the modular vertical take-off and landing station comprises an enclosure, a communication system, a command console, an internal resource bunker, and the landing carousel (as previously depicted in exemplary form). The enclosure defines a rigid outer shell of suitable shape and dimensions to enclose all other subcomponents of the modular vertical take-off and landing station in at least one configuration suitable for shipment and transport by conventional means. Specifically, the enclosure is contemplated to define a standardized shipping enclosure of dimensions that may be recognized by individuals skilled in the industry to be suitable for handling and storage via conventional means typically associated with the long-distance transport of freight or other bulk cargo. The standardization of the outer dimensions enables an operator to pack and relocate utilizing standard means and methods, avoiding the additional cost or incompatibilities associated with the creation of a bespoke or non-standard iteration of the enclosure. Further, standard cargo containers may be internally retrofit to create instances of the modular vertical take-off and landing station at a minimum of expense. The communication system defines any means of method that the operator may utilize to operably link the modular vertical take-off and landing station to any associated vehicles, airborne, landed, or otherwise. Further consideration is given to the establishment of a mesh network connection between remote instances of the communication system, wherein command and control of vehicles beyond the maximum range of a single installation may be affected via signals relayed via this network. Further provisions are contemplated for the establishment of hardline and wireless connection to conventional network access points and wide-area networks; the Internet, generally. The command console comprises the direct user-operable portions of the modular vertical take-off and landing station, ideally including reconfigurable operable controls and displays as may be required to effectively monitor and operate the vehicles associated with the modular vertical take-off and landing station. Further, the command console will enable a single operator to establish contact and control of any vehicle accessible via the communication system, without limitation to network route or volume of concurrent linked vehicles. Further, the operator may configure aspects of the command console to autonomously monitor and guide various operations of a managed fleet of vehicles, absent direct input from a human operator. The capacities defined within and enabled by the command console defines a series of internal functions related to the capture, retention, resupply, reconfiguration, and launch of any vehicles from the modular vertical take-off and landing station as may be required for any operations as may be considered in relation to an individual node in an airborne logistics network. In at least one embodiment of the present disclosure, an ambient observation and impact-mitigation functionality may be integrated to the command console, specifically providing a means for reducing the nuisance value of an installation to a surrounding area. In relation to the physical installation and arrangement of the command console, considerations may be given to the installation of various amenities and features within the enclosure to enable extended occupation or promote operator comfort as required without departing from the spirit or scope of the present disclosure. The internal resource bunker defines any collection of redistributable materiel to be transferred to or from any vehicles landed at the modular vertical take-off and landing station. Further, the internal resource bunker will define a rechargeable battery pack of suitable capacity to provide power to the land-based operations of the modular vertical take-off and landing station while resupplying any fleet vehicles via fast-charging means and methods as may be recognized within the relevant fields. It is also considered that means of recharging these battery packs may be associated with an installation of the modular vertical take-off and landing station, either via direct connection to a local grid, external generators, or deployable renewable generators. Further embodiments of the internal resource bunker may provide storage and dispensation of conventional fuels or other supplies as may be required for the continued operation of any associated vehicles. In conjunction with the command console, the landing carousel defines the physical construct maneuvering individual vehicles between a load-unload position, a resupply status, and a landing/takeoff area as necessary for the proposed functions supported by the modular vertical take-off and landing station specifically and a dispersed logistic network generally.

Further, the enclosure comprises a hangar, an operator compartment, a cargo compartment, a plurality of handlers, and at least one external mount. Further, the hangar provides a secure area to handle all operations concerning handling of vehicles by the landing carousel and the supply bunker. In consideration of the requirements for shipping and installation security, it is specifically considered that the hangar may be sealed by the operator or automatically by the landing carousel as may be suitable or preferable based on prevailing operational conditions. The operator compartment is ideally subdivided from the hangar, such that an operator situated therein may not be exposed to the vehicles directly during normal operations. Specifically, the operator compartment is contemplated to define a sealable module of any arbitrary installation of the modular vertical take-off and landing station, connectable either physically, digitally, or both to the hangar such that control may be established over the landing carousel contained therein. The cargo compartment similarly defines a module within the enclosure, specifically for storing non-consumable goods that may be picked up from or delivered to the modular vertical take-off and landing station. The cargo compartment ideally defines a section of the enclosure opposite the operator compartment across the hangar but may alternately define a separate module entirely. In this alternate instance, the cargo compartment will be physically linked adjacent to the hangar, such that the plurality of handlers may engage any vehicles in the hangar to capture any cargo retained thereon. Further, the plurality of handlers may define a series of accessible portals in a lateral side of the enclosure wherein customers or users may selectively access and retrieve cargo from said portals to take or make delivery of said cargo. Each instance of the enclosure will feature at least one external mount, herein understood to define a standard physical hitch, hard-point, or any other interlocking structure as may be found on conventional cargo containers. The external mount may provide a means of fixing the enclosure to standardized trucks, railcars, boats, or freight-handling machinery in general to permit ease of transport via conventional means. Further, the external mount may be employed to physically link instances of the enclosure into a modular construct, e.g. fixing the cargo compartment to the hangar, or the hangar to the operator compartment. Additional consideration is given to the connection of specialized instances of the enclosure to expand functionality beyond the capacity of a single operational installation. In one instance, a first module supporting the internal resource bunker may be linked to the modular vertical take-off and landing station of standard construction (i.e. one of each functional component as described) to increase the reserve of useable fuel or power, enabling extended off-grid operations. In another instance, a second module containing an instance of the landing carousel may be linked to a similar standard installation, expanding the number of vehicles that may be serviced or maintained simultaneously. The modular nature of the present disclosure is considered to provide operational flexibility in any conceivable combination of the distinct components described herein, without limitation to quantity of iterated modules.

The communication system comprises a plurality of first transceivers, a plurality of second transceivers, at least one uplink, and at least one network controller. The plurality of first transceivers defines both the hardware and software aspects of any long-range wireless communications functionality related to the remote operation and monitoring of a dispersed fleet of vehicles and remote installations. The frequencies, codecs, protocols, or any other variable aspect of these long-range communications functionalities are considered to be readily apparent to any reasonably skilled individual and may be adjusted as required without departing from the spirit or scope of the present disclosure. Similarly, the plurality of second transceivers are contemplated to define and enable any near-field or short-range communications functions as may be required for the effective operation of the modular vertical take-off and landing station in various embodiments. The plurality of second transceivers are considered to be applicable to functions both internal and external to the enclosure, e.g. a user accessing a wireless local area network via Wi-Fi or an arbitrary vehicle broadcasting status and position data via a Bluetooth array. At least one uplink is specifically considered to enable the interconnection of the network controller to remote operators, or additional instances of the modular vertical take-off and landing station. Via the network controller, commands to vehicles may be relayed between various instances of the modular vertical take-off and landing station acting as relay nodes in an otherwise conventional network arrangement.

The command console comprises a plurality of displays, at least one human interface device, a dashboard, at least one processor, and at least one database. The plurality of displays defines any combination of monitors, projectors, or remote terminals that may be utilized to visualize data related to, or video telemetry from and vehicle related to the modular vertical take-off and landing station. The human interface device, in conjunction, defines any means of accepting input commands linked to the plurality of displays, including conventional keyboards and pointing devices. Further embodiments of the human interface device may include touchscreen, or control schemes suitable for direct operation of any vehicle, i.e. a virtual cockpit assembly. Visualization of data and direct display of video telemetry is understood to be rendered via the dashboard, defining a graphic user interface of suitable complexity and capability to support operators in attaining all functionalities of the modular vertical take-off and landing station presently described. It is understood that the dashboard may be modified to optimize an interface with various types of vehicles, or to more effectively visualize relevant data without departing from the original scope of the present disclosure. Supporting the digital functions described herein, at least one processor and at least one database define a means and method of manipulating and storing any digital data as may be required by an operator. Alterations to the quality and/or disposition of the processor and the database are considered to be easily realized by any reasonably skilled individual, or otherwise may be reconfigurable to suit alternate use-cases and applications.

The internal resource bunker comprises a reservoir, a resupply mechanism, and at least one external connection. The reservoir defines a storage medium for any consumables related to the operation of the vehicle fleet, specifically y fuel or electrical energy that may be transferred to the vehicles retained within the landing carousel. Further, the reservoir will comprise acellular battery pack and integral battery management system suitable for deployment in conjunction with other elements of the modular vertical take-off and landing station. The resupply mechanism defines any means of transferring the contents of the reservoir to vehicles, including capacitive charging pads, direct-contact connections, fluid transfer pumps, or any other suitable mechanism as may be applied in various embodiments described herein. In at least one instance, the resupply mechanism may be integrated to the landing carousel to engage with vehicles automatically as said vehicles make a landing thereon, enabling shorter turnaround periods for basic resupply operations. The external connection defines a means of linking the reservoir to any adjacent source of fuel, power, or other consumable. In one instance, the external connection may enable the interconnection of multiple installations of the reservoir as previously outlined in relation to the compound installations achievable via reconfiguration of the modular vertical take-off and landing station. In another instance, the external connection may permit the reservoir to be replenished by an external generator or power source.

Further, the landing carousel comprises a frame, a plurality of rails, a plurality of actuators, and a plurality of disruption devices. The frame defines a superstructure from which the plurality of rails protrudes perpendicularly. The plurality of rails ideally defines a series of hollow channels suitable for supporting at least one first platform and at least one first platform laterally arranged such that the first panel and the second panel may traverse the plurality of rails independently. The plurality of actuators provides motive force to affect the disposition of the first panel and second panel independently, based on instructions issued via the command console. Further, the adjacent arrangement of the first and second panel will ideally provide a suitable landing platform for large craft roughly equivalent in dimension to the lateral width of the hanger. To service such craft, the first panel and the second panel will be extended and retracted in concert, effectively forming a single mobile surface. To provide efficient means of servicing smaller craft, the first panel and the second panel may be operated independently, allowing for takeoff or landing operations to be performed simultaneously with resupply or refit operations. It is further considered that the first panel and the second panel may be arranged vertically; wherein the first panel may be retracted to clear the airspace above the second panel to permit takeoff or landing on the lower second panel. This operational order is extrapolated to include instances wherein the first panel and the second panel may be arranged to provide a landing surface for large vehicles in conjunction with operations suitable for the independent handling of small vehicles. The plurality of disruption devices ideally constitutes an array of microphones and speakers disperses about the hangar. This arrangement is contemplated to be employed to capture the sounds generated by the vehicles during takeoff and landing, said sounds converted to waveform within the command console, and reproduced in negative to muffle or cancel the sounds of the vehicles. This functionality is specifically contemplated to reduce the nuisance created by the modular vertical take-off and landing station to nearby persons, enabling installations to be positioned in proximity to inhabited areas without aggravating the local populace.

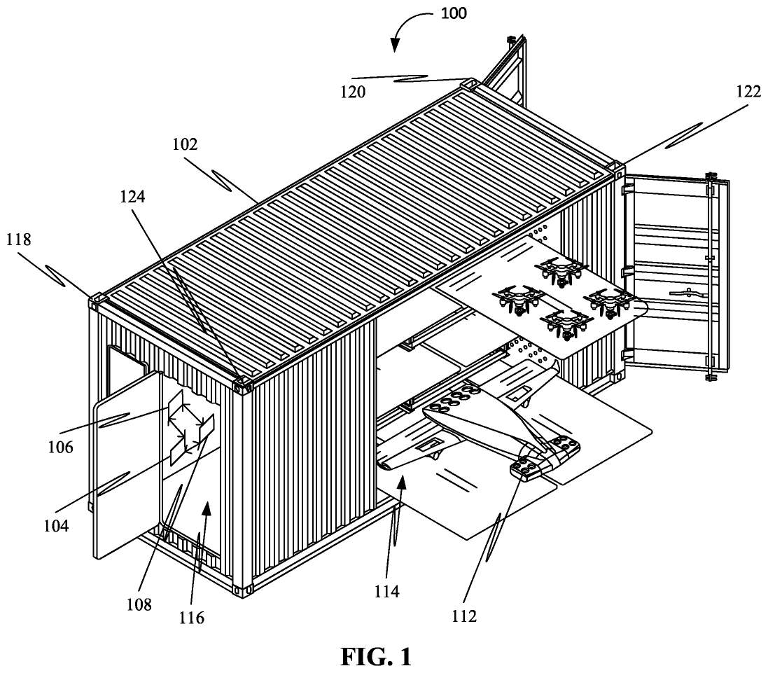

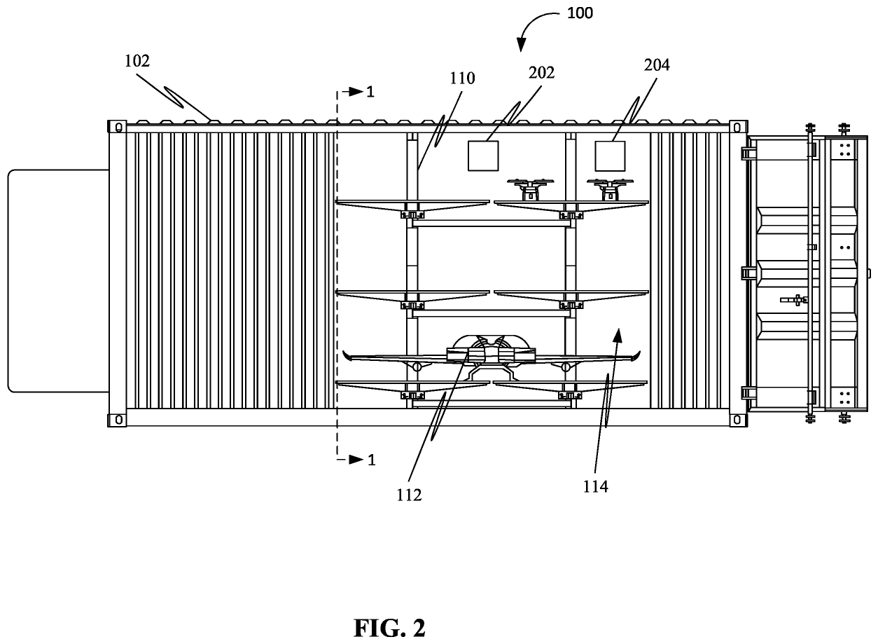

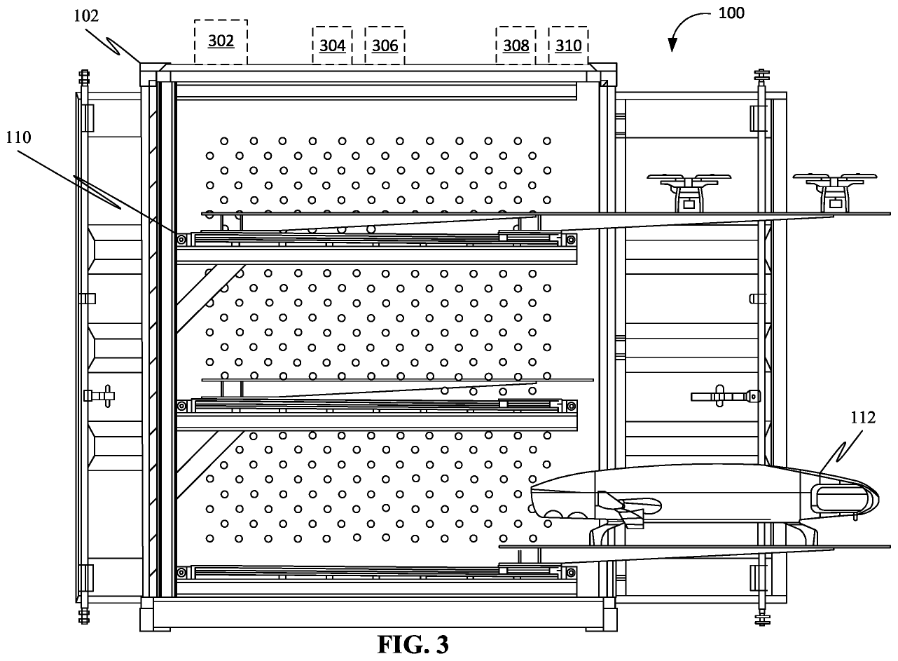

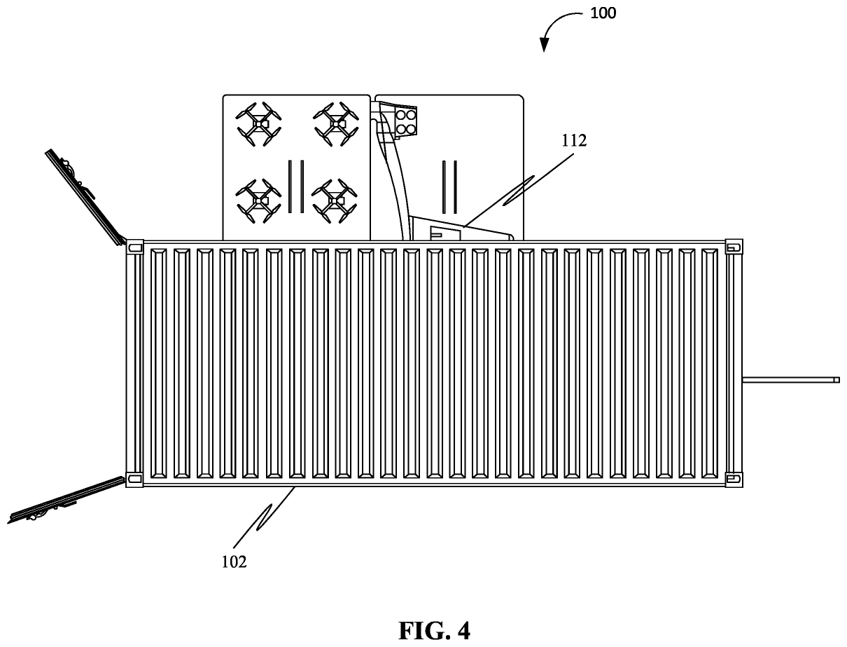

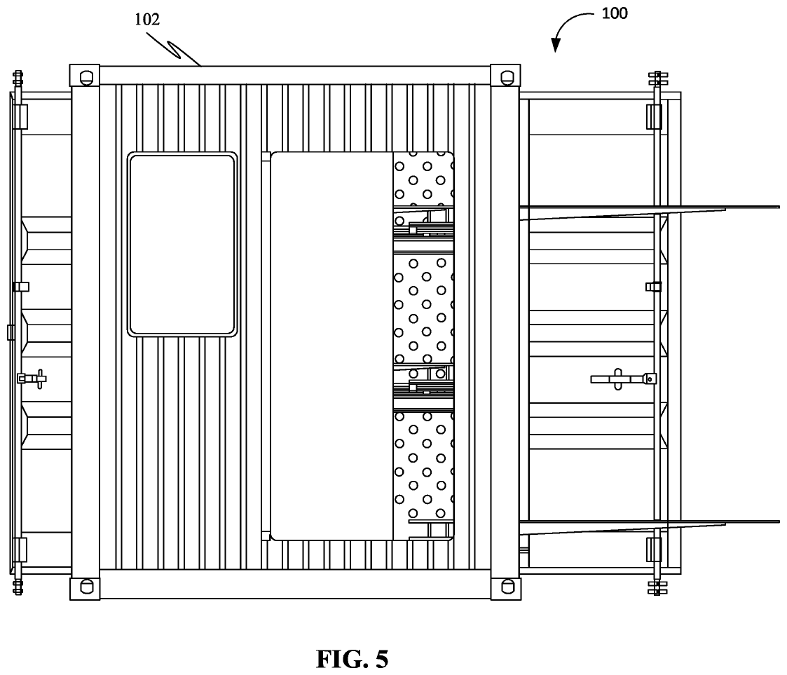

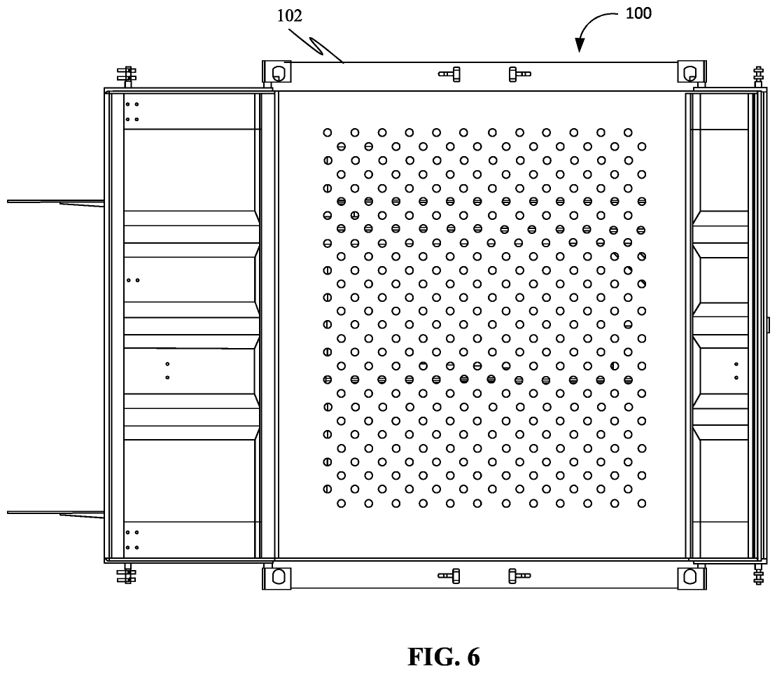

FIG. 1 is a front top left side perspective view of a modular autonomous aircraft control and resupply station 100, in accordance with some embodiments. FIG. 2 is a front view of the modular autonomous aircraft control and resupply station 100, in accordance with some embodiments. FIG. 3 is a cross-section view of the modular autonomous aircraft control and resupply station 100 along line 1-1 of FIG. 2, in accordance with some embodiments. FIG. 4 is a top view of the modular autonomous aircraft control and resupply station 100, in accordance with some embodiments. FIG. 5 is a left side view of the modular autonomous aircraft control and resupply station 100, in accordance with some embodiments. FIG. 6 is a rear view of the modular autonomous aircraft control and resupply station 100, in accordance with some embodiments.

Further, the modular autonomous aircraft control and resupply station 100 may include an enclosure 102 comprising a rigid outer shell configured to enclose each component of the modular autonomous aircraft control and resupply station 100.

In some embodiments, the enclosure 102 may be configured for shipment and transport by a conventional transportation means.

In further embodiments, the enclosure 102 may include an intermodal shipping container configured according to at least one of ISO 668 and ISO 1496-1.

Further, the modular autonomous aircraft control and resupply station 100 may include a communication system 104 configured to communicate with at least one of a vehicle 112 and a remote system.

In some embodiments, the communication system 104 may include a plurality of first transceivers configured to provide long range communication and a plurality of second transceivers configured to provide short range communication.

In further embodiments, the remote system may include a second communication system of a second modular autonomous aircraft control and resupply station forming a mesh network of a plurality of modular autonomous aircraft control and resupply stations.

Further, the modular autonomous aircraft control and resupply station 100 may include a command console 106 configured to provide a user interface to an operator. Further, the user interface may include a display device configured to display operational data associated with at least one of modular autonomous aircraft control and resupply station 100 and a vehicle 112 associated therewith and an input device configured to receive a command from the operator.

In further embodiments, the command console 106 may be configured to autonomously monitor and guide a plurality of operations of a managed fleet of vehicles associated with the modular autonomous aircraft control and resupply station 100. In some embodiments, the plurality of operations may include at least two of capture, retention, resupply, reconfiguration and launch.

Further, the modular autonomous aircraft control and resupply station 100 may include an internal resource bunker 202 (shown in FIG. 2) configured to house a plurality of redistributable materials to be transferred onto and received from the vehicle 112. In some embodiments, the plurality of redistributable materials may include fuel.

In some embodiments, the internal resource bunker 202 may include a rechargeable battery pack.

Further, the modular autonomous aircraft control and resupply station 100 may include a landing carousel 110 configured to maneuver the vehicle 112.

Further, the modular autonomous aircraft control and resupply station 100 may include a power source 108 configured to provide electrical power to operate one or more components of the modular autonomous aircraft control and resupply station 100.

In some embodiments, the power source 108 may include at least one of a fuel based power generator and a renewable energy based power generator.

In further embodiments, the modular autonomous aircraft control and resupply station 100 may include an ambient observation and impact-mitigation functionality 302 (shown in FIG. 3) configured for reducing a nuisance value of modular autonomous aircraft control and resupply station 100 to a surrounding area.

According to further embodiments, the enclosure 102 may include a hangar 114 configured to provide a secure area to perform operations associated with each of handling of the vehicle 112 by the landing carousel 110 and the internal resource bunker 202.

According to further embodiments, the enclosure 102 may include an operator compartment 116 subdivided from the hangar 114. Further, the operator compartment 116 may be configured to shelter the operator. Further, the operator situated therein may be not directly exposed to the vehicle 112.

According to further embodiments, the enclosure 102 may include a cargo compartment 204 (shown in FIG. 2) configured to store a non-consumable item. Further, the cargo may include the non-consumable item.

According to further embodiments, the enclosure 102 may include a plurality of handlers (not shown) may include a series of accessible portals in a lateral side of the enclosure 102. Further, the operator can selectively access and retrieve cargo from the series of accessible portals.

According to further embodiments, the enclosure 102 may include at least one external mount 118-124 configured to fix the enclosure 102 to a freight-handling machinery, Further, the at least one external mount 118-124 may be configured to link the enclosure 102 to a second enclosure of a second modular autonomous aircraft control and resupply station configured to extend at least one functionality of the modular autonomous aircraft control and resupply station 100.

According to some embodiments, at least one of the landing carousel 110 and the enclosure 102 may include a plurality of disruption devices. The plurality of disruption devices may include an array of microphones 304-306 (shown in FIG. 3) configured to capture a vehicle sound generated by the vehicle 112 during at least one of take-off and landing. Further, the array of microphones 304-306 may be communicatively coupled to the command console 106.

Further, the plurality of disruption devices may include an array of speakers 308-310 communicatively coupled to the command console 106. Further, the array of speakers 308-310 may be configured to generate sound. Further, the command console 106 may include a processor configured to generate a negative vehicle sound configured to cancel the vehicle sound when reproduced through the array of speakers 308-310.

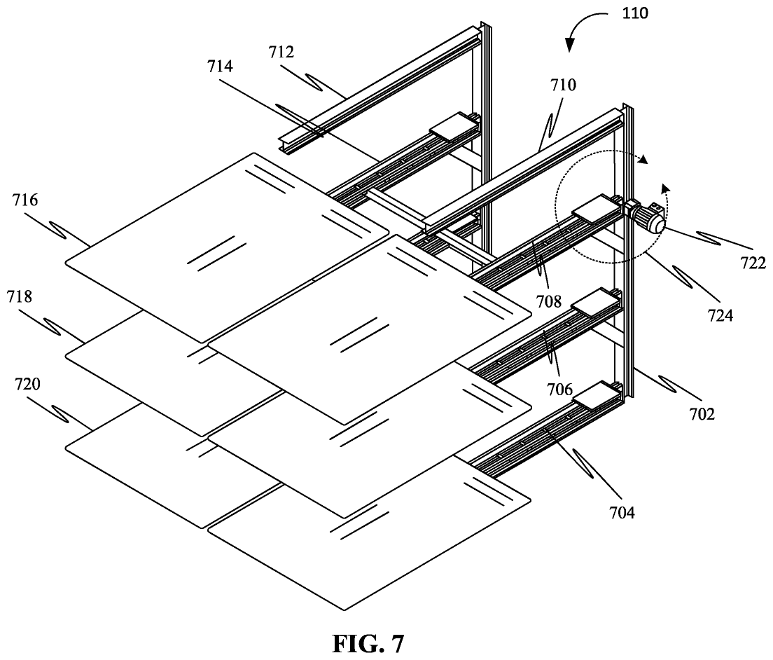

FIG. 7 is a front top right side perspective view of the landing carousel 110, in accordance with some embodiments. Further, the landing carousel 110 may include a frame 702. Further, the landing carousel 110 may include a plurality of rails 704-714 attached to the frame 702. Further, the plurality of rails 704-714 protrudes perpendicularly from the frame 702.

Further, the landing carousel 110 may include at least one platform 716-720 configured to be operationally coupled to the plurality of rails 704-714. Further, the at least one platform 716-720 may be configured to be moved along the plurality of rails 704-714. Further, the at least one platform 716-720 may include a plurality of panels.

Further, the landing carousel 110 may include at least one actuator 722 operationally coupled to the at least one platform 716-720. Further, the at least one actuator 722 may be configured to provide a motive force to affect the disposition of the plurality of panels.

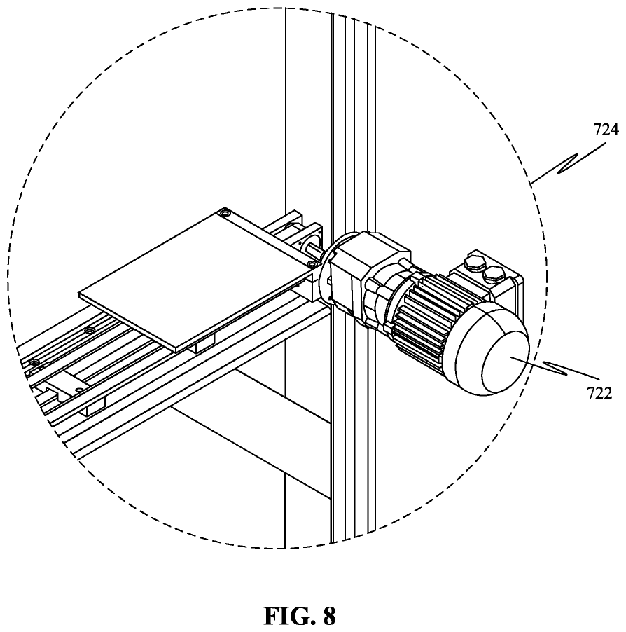

FIG. 8 is a close-up perspective view of an area 724 of FIG. 7, in accordance with some embodiments. FIG. 8 shows a close-up perspective view of the at least one actuator 722.

Further, the plurality of rails 704-714 may include a series of hollow channels configured to support at least one first platform. Further, the at least one first platform may be laterally arranged. Further, the at least one first platform may include a plurality of panels. Further, each panel may be configured to traverse the plurality of rails 704-714 independently.

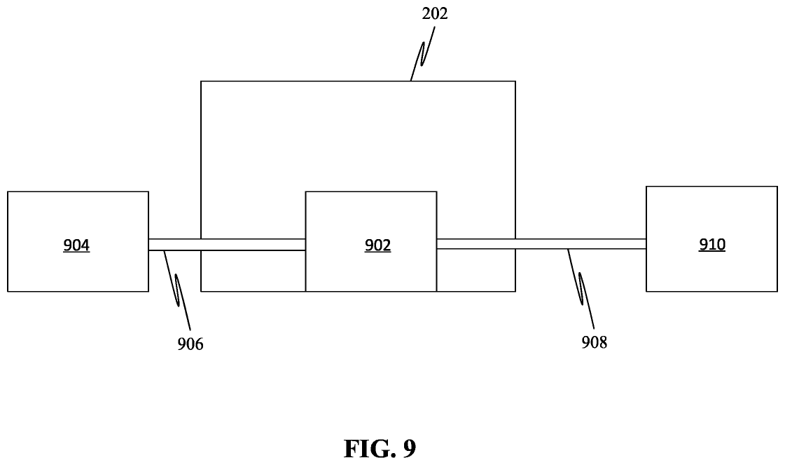

FIG. 9 is a schematic of the internal resource bunker 202, in accordance with some embodiments. Further, the internal resource bunker 202 may include a reservoir 902 configured to store at least one consumable associated with a vehicle 904 (the vehicle 112). In some embodiments, the at least one consumable may include at least one of a combustible fuel.

Further, the internal resource bunker 202 may include a resupply mechanism 906 operationally coupled to the reservoir 902 and the landing carousel 110. Further, the resupply mechanism 906 may be configured to transfer the at least one consumable between the reservoir 902 and the vehicle 904.

Further, the internal resource bunker 202 may include at least one external connection 908 operationally coupled to the reservoir 902 and configured to be coupled to an external source 910. Further, the at least one external connection 908 may be further configured to facilitate transfer of the at least one consumable between the reservoir 902 and the external source 910.

In some embodiments, the at least one consumable may include a battery pack. Accordingly, a resupply mechanism a may include at least one of a capacitive charging pad, a direct-contact connection and a fluid transfer pump.

According to some embodiments, a modular autonomous aircraft control and resupply station 100 is disclosed. Further, the modular autonomous aircraft control and resupply station 100 may include an enclosure 102 may include a rigid outer shell configured to enclose each component of the modular autonomous aircraft control and resupply station 100. Further, the enclosure 102 may include at least one external mount 118-124 configured to fix the enclosure 102 to a freight-handling machinery and further configured to link the enclosure 102 to a second enclosure of a second modular autonomous aircraft control and resupply station configured to extend at least one functionality of the modular autonomous aircraft control and resupply station 100.

Further, the modular autonomous aircraft control and resupply station 100 may include a communication system 104 configured to communicate with at least one of a vehicle 112 of a managed fleet of vehicles and a remote system.

Further, the modular autonomous aircraft control and resupply station 100 may include a command console 106 configured to provide a user interface to an operator. Further, the user interface may include a display device configured to display operational data associated with at least one of modular autonomous aircraft control and resupply station 100 and a vehicle 112 associated therewith and an input device configured to receive a command from the operator. Further, the command console 106 may be further configured to autonomously monitor and guide a plurality of operations of a managed fleet of vehicles associated with the modular autonomous aircraft control and resupply station 100.

Further, the modular autonomous aircraft control and resupply station 100 may include an internal resource bunker 202 (shown in FIG. 2) configured to house a plurality of redistributable materials to be transferred onto and received from a vehicle 112.

Further, the modular autonomous aircraft control and resupply station 100 may include a landing carousel 110 configured to maneuver the vehicle 112.

Further, the modular autonomous aircraft control and resupply station 100 may include a power source 108 configured to provide electrical power to operate one or more components of the modular autonomous aircraft control and resupply station 100.

According to some embodiments, a modular autonomous aircraft control and resupply station 100 is disclosed. Further, the modular autonomous aircraft control and resupply station 100 may include an enclosure 102 comprising a rigid outer shell configured to enclose each component of the modular autonomous aircraft control and resupply station 100. Further, the enclosure 102 may include at least one external mount 118-124 configured to fix the enclosure 102 to a freight-handling machinery and further configured to link the enclosure 102 to a second enclosure of a second modular autonomous aircraft control and resupply station configured to extend at least one functionality of the modular autonomous aircraft control and resupply station 100.

Further, the enclosure 102 may include an intermodal shipping container configured according to at least one of ISO 668 and ISO 1496-1.

Further, the modular autonomous aircraft control and resupply station 100 may include a communication system 104 configured to communicate with at least one of a vehicle 112 of a managed fleet of vehicles and a remote system.

Further, the modular autonomous aircraft control and resupply station 100 may include a command console 106 configured to provide a user interface to an operator. Further, the user interface may include a display device configured to display operational data associated with at least one of modular autonomous aircraft control and resupply station 100 and a vehicle 112 associated therewith and an input device configured to receive a command from the operator. Further, the command console 106 may be configured to autonomously monitor and guide a plurality of operations of a managed fleet of vehicles associated with the modular autonomous aircraft control and resupply station 100.

Further, the modular autonomous aircraft control and resupply station 100 may include an internal resource bunker 202 (shown in FIG. 2) configured to house a plurality of redistributable materials to be transferred onto and received from a vehicle 112.

Further, the modular autonomous aircraft control and resupply station 100 may include a landing carousel 110 configured to maneuver the vehicle 112. Further, the landing carousel 110 may include a plurality of disruption devices.

Further, the plurality of disruption devices may include an array of microphones 304-306 configured to capture a vehicle sound generated by the vehicle 112 during at least one of take-off and landing. Further, the array of microphones 304-306 may be communicatively coupled to the command console 106.

Further, the plurality of disruption devices may include an array of speakers 308-310 communicatively coupled to the command console 106. Further, the array of speakers 308-310 may be configured to generate sound. Further, the command console 106 may include a processor configured to generate a negative vehicle sound configured to cancel the vehicle sound when reproduced through the array of speakers 308-310.

Further, the modular autonomous aircraft control and resupply station 100 may include a power source 108 configured to provide electrical power to operate one or more components of the modular autonomous aircraft control and resupply station 100.

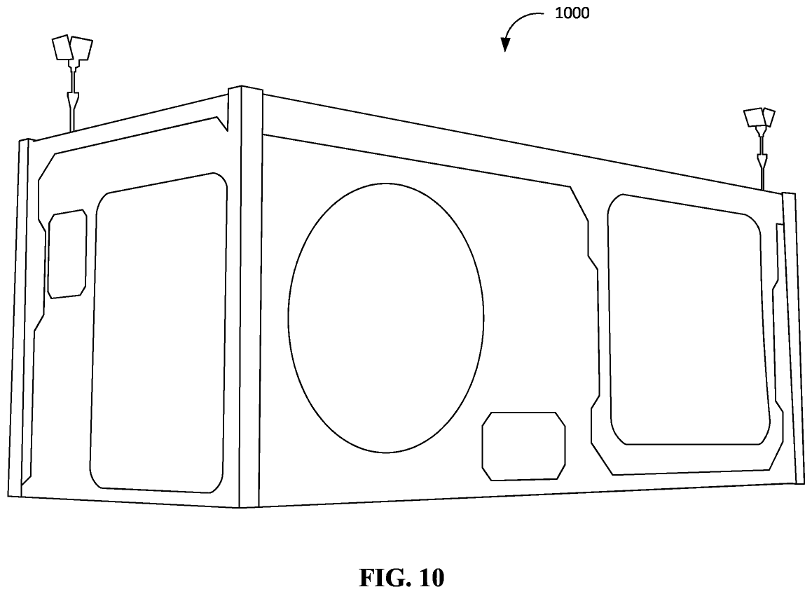

FIG. 10 is a front top left side perspective view of a modular autonomous aircraft control and resupply station 1000, in accordance with some embodiments.

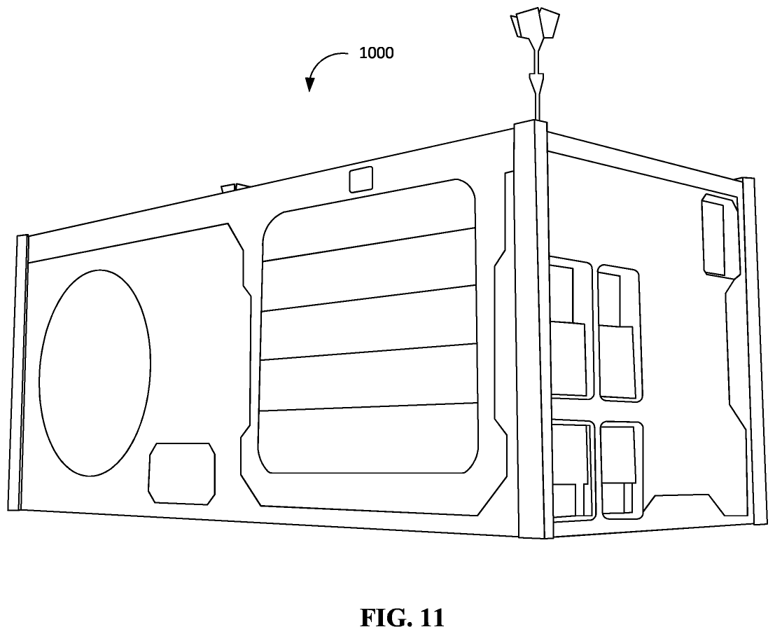

FIG. 11 is a front top right side perspective view of the modular autonomous aircraft control and resupply station 1000.

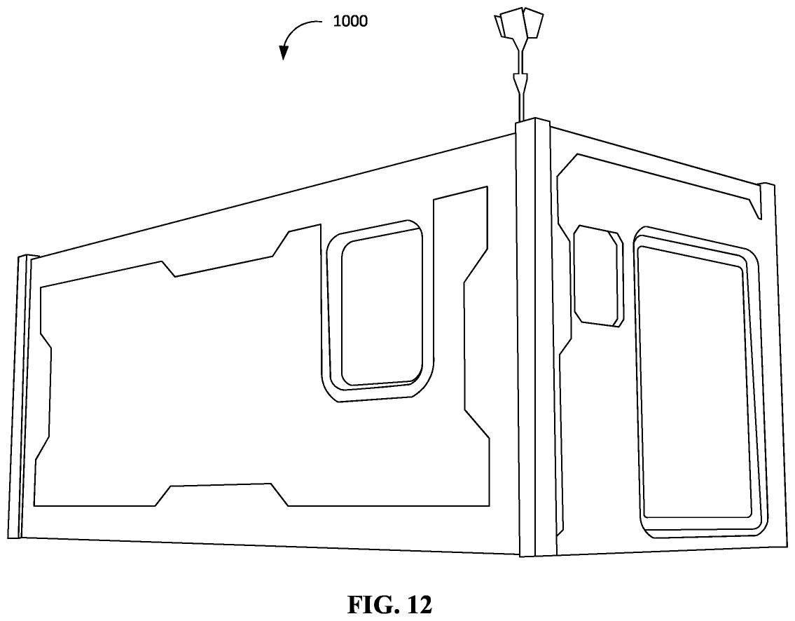

FIG. 12 is a rear left side perspective view of the modular autonomous aircraft control and resupply station 1000.

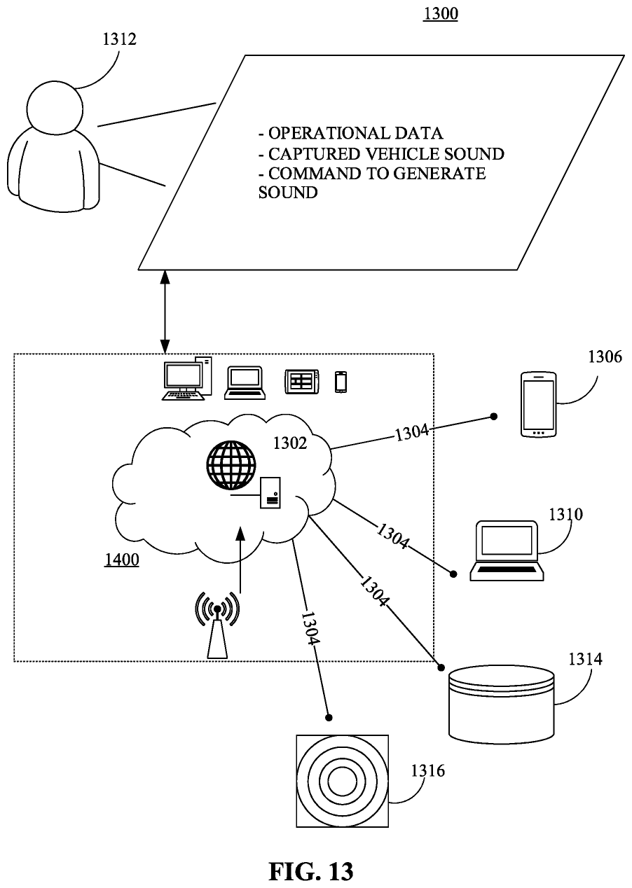

FIG. 13 is an illustration of an online platform 1300 consistent with various embodiments of the present disclosure. By way of non-limiting example, the online platform 1300 to facilitate operation of a modular autonomous aircraft control and resupply station may be hosted on a centralized server 1302, such as, for example, a cloud computing service. The centralized server 1302 may communicate with other network entities, such as, for example, a mobile device 1306 (such as a smartphone, a laptop, a tablet computer etc.), other electronic devices 1310 (such as desktop computers, server computers etc.), databases 1314, and sensors 1316 (such as microphones) over a communication network 1304, such as, but not limited to, the Internet. Further, users of the online platform 1300 may include relevant parties such as, but not limited to, end-users, operators, drone pilots, administrators, service providers, service consumers and so on. Accordingly, in some instances, electronic devices operated by the one or more relevant parties may be in communication with the platform.

A user 1312, such as the one or more relevant parties, may access online platform 1300 through a web based software application or browser. The web based software application may be embodied as, for example, but not be limited to, a website, a web application, a desktop application, and a mobile application compatible with a computing device 1400.

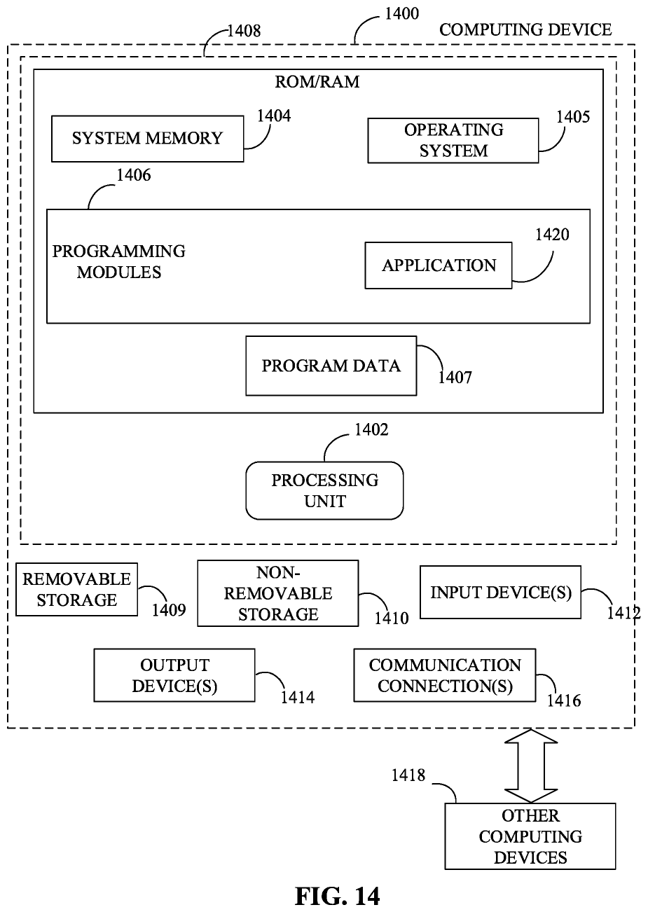

With reference to FIG. 14, a system consistent with an embodiment of the disclosure may include a computing device or cloud service, such as computing device 1400. In a basic configuration, computing device 1400 may include at least one processing unit 1402 and a system memory 1404. Depending on the configuration and type of computing device, system memory 1404 may comprise, but is not limited to, volatile (e.g. random-access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling computing device 1400's operation. In one embodiment, programming modules 1406 may include a negative vehicle sound generating module. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and non-volatile, removable and non-removable media implemented in any method or technology for storage of information, such as computer-readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1400. Any such computer storage media may be part of device 1400. Computing device 1400 may also have input device(s) 1412 such as a keyboard, a mouse, a pen, a sound input device, a touch input device, a location sensor, a camera, a biometric sensor, etc. Output device(s) 1414 such as a display, speakers, a printer, etc. may also be included. The aforementioned devices are examples and others may be used.

Computing device 1400 may also contain a communication connection 1416 that may allow device 1400 to communicate with other computing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1404, including operating system 1405. While executing on processing unit 1402, programming modules 1406 (e.g., application 1420) may perform processes including, for example, one or more stages of methods, algorithms, systems, applications, servers, databases as described above. The aforementioned process is an example, and processing unit 1402 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A modular autonomous aircraft control and resupply station comprising:
an enclosure comprising a rigid outer shell configured to enclose each component of the modular autonomous aircraft control and resupply station;
a communication system configured to communicate with at least one of a vehicle and a remote system;
a command console configured to provide a user interface to an operator, wherein the user interface comprises a display device configured to display operational data associated with at least one of modular autonomous aircraft control and resupply station and a vehicle associated therewith and an input device configured to receive a command from the operator;
an internal resource bunker configured to house a plurality of redistributable materials to be transferred onto and received from the vehicle;
a landing carousel configured to maneuver the vehicle; and
a power source configured to provide electrical power to operate one or more components of the modular autonomous aircraft control and resupply station.

2. The modular autonomous aircraft control and resupply station of claim 1, wherein the enclosure is configured for shipment and transport by a conventional transportation means.

3. The modular autonomous aircraft control and resupply station of claim 2, wherein the enclosure comprises an intermodal shipping container configured according to at least one of ISO 668 and ISO 1496-1.

4. The modular autonomous aircraft control and resupply station of claim 1, wherein the remote system comprises a second communication system of a second modular autonomous aircraft control and resupply station forming a mesh network of a plurality of modular autonomous aircraft control and resupply stations.

5. The modular autonomous aircraft control and resupply station of claim 1, wherein the command console is configured to autonomously monitor and guide a plurality of operations of a managed fleet of vehicles associated with the modular autonomous aircraft control and resupply station.

6. The modular autonomous aircraft control and resupply station of claim 1, wherein the plurality of operations comprises at least two of capture, retention, resupply, reconfiguration and launch.

7. The modular autonomous aircraft control and resupply station of claim 1 further comprises an ambient observation and impact-mitigation functionality configured for reducing a nuisance value of modular autonomous aircraft control and resupply station to a surrounding area.

8. The modular autonomous aircraft control and resupply station of claim 1, wherein the internal resource bunker comprises a rechargeable battery pack.

9. The modular autonomous aircraft control and resupply station of claim 1, wherein the power source comprises at least one of a fuel based power generator and a renewable energy based power generator.

10. The modular autonomous aircraft control and resupply station of claim 1, wherein the plurality of redistributable materials comprises fuel.

11. The modular autonomous aircraft control and resupply station of claim 1, wherein the enclosure comprises:
a hangar configured to provide a secure area to perform operations associated with each of handling of the vehicle by the landing carousel and the internal resource bunker;
an operator compartment subdivided from the hangar, wherein the operator compartment is configured to shelter the operator, wherein the operator situated therein is not directly exposed to the vehicle;
a cargo compartment configured to store a non-consumable item;
a plurality of handlers comprises a series of accessible portals in a lateral side of the enclosure, wherein the operator can selectively access and retrieve cargo from the series of accessible portals, wherein the cargo comprises the non-consumable item; and
at least one external mount configured to fix the enclosure to a freight-handling machinery.

12. The modular autonomous aircraft control and resupply station of claim 11, wherein the at least one external mount is configured to link the enclosure to a second enclosure of a second modular autonomous aircraft control and resupply station configured to extend at least one functionality of the modular autonomous aircraft control and resupply station.

13. The modular autonomous aircraft control and resupply station of claim 1, wherein the communication system comprises:
a plurality of first transceivers configured to provide long range communication; and
a plurality of second transceivers configured to provide short range communication.

14. The modular autonomous aircraft control and resupply station of claim 1, wherein the internal resource bunker comprises:
a reservoir configured to store at least one consumable associated with the vehicle;
a resupply mechanism operationally coupled to the reservoir and the landing carousel, wherein the resupply mechanism is configured to transfer the at least one consumable between the reservoir and the vehicle; and
at least one external connection operationally coupled to the reservoir and configured to be coupled to an external source, wherein the at least one external connection is further configured to facilitate transfer of the at least one consumable between the reservoir and the external source.

15. The modular autonomous aircraft control and resupply station of claim 14, wherein the at least one consumable comprises at least one of a combustible fuel and a battery pack, wherein the resupply mechanism comprises at least one of a capacitive charging pad, a direct-contact connection and a fluid transfer pump.

16. The modular autonomous aircraft control and resupply station of claim 1, wherein the landing carousel comprises:
a frame;
a plurality of rails attached to the frame, wherein the plurality of rails protrudes perpendicularly from the frame;
at least one platform configured to be operationally coupled to the plurality of rails, wherein the at least one platform is configured to be moved along the plurality of rails, wherein the at least one platform comprises a plurality of panels;
at least one actuator operationally coupled to the at least one platform, wherein the at least one actuator is configured to provide a motive force to affect the disposition of the plurality of panels; and
a plurality of disruption devices comprising:
an array of microphones configured to capture a vehicle sound generated by the vehicle during at least one of take-off and landing, wherein the array of microphones is communicatively coupled to the command console; and
an array of speakers communicatively coupled to the command console, wherein the array of speakers is configured to generate sound, wherein the command console comprises a processor configured to generate a negative vehicle sound configured to cancel the vehicle sound when reproduced through the array of speakers.

17. The modular autonomous aircraft control and resupply station of claim 16, wherein the plurality of rails comprises a series of hollow channels configured to support at least one first platform, wherein the at least one first platform is laterally arranged, wherein the at least one first platform comprises a plurality of panels, wherein each panel is configured to traverse the plurality of rails independently.

18. A modular autonomous aircraft control and resupply station comprising:
an enclosure comprising a rigid outer shell configured to enclose each component of the modular autonomous aircraft control and resupply station, wherein the enclosure comprises at least one external mount configured to fix the enclosure to a freight-handling machinery and further configured to link the enclosure to a second enclosure of a second modular autonomous aircraft control and resupply station configured to extend at least one functionality of the modular autonomous aircraft control and resupply station;
a communication system configured to communicate with at least one of a vehicle of a managed fleet of vehicles and a remote system;
a command console configured to provide a user interface to an operator, wherein the user interface comprises a display device configured to display operational data associated with at least one of modular autonomous aircraft control and resupply station and a vehicle associated therewith and an input device configured to receive a command from the operator, wherein the command console is further configured to autonomously monitor and guide a plurality of operations of a managed fleet of vehicles associated with the modular autonomous aircraft control and resupply station;
an internal resource bunker configured to house a plurality of redistributable materials to be transferred onto and received from a vehicle;
a landing carousel configured to maneuver the vehicle; and
a power source configured to provide electrical power to operate one or more components of the modular autonomous aircraft control and resupply station.

19. A modular autonomous aircraft control and resupply station comprising:
an enclosure comprising a rigid outer shell configured to enclose each component of the modular autonomous aircraft control and resupply station, wherein the enclosure comprises at least one external mount configured to fix the enclosure to a freight-handling machinery and further configured to link the enclosure to a second enclosure of a second modular autonomous aircraft control and resupply station configured to extend at least one functionality of the modular autonomous aircraft control and resupply station;
a communication system configured to communicate with at least one of a vehicle of a managed fleet of vehicles and a remote system;
a command console configured to provide a user interface to an operator, wherein the user interface comprises a display device configured to display operational data associated with at least one of modular autonomous aircraft control and resupply station and a vehicle associated therewith and an input device configured to receive a command from the operator, wherein the command console is further configured to autonomously monitor and guide a plurality of operations of a managed fleet of vehicles associated with the modular autonomous aircraft control and resupply station;
an internal resource bunker configured to house a plurality of redistributable materials to be transferred onto and received from a vehicle;
a landing carousel configured to maneuver the vehicle, wherein the landing carousel further comprises a plurality of disruption devices comprising:
an array of microphones configured to capture a vehicle sound generated by the vehicle during at least one of take-off and landing, wherein the array of microphones is communicatively coupled to the command console; and
an array of speakers communicatively coupled to the command console, wherein the array of speakers is configured to generate sound, wherein the command console comprises a processor configured to generate a negative vehicle sound configured to cancel the vehicle sound when reproduced through the array of speakers; and
a power source configured to provide electrical power to operate one or more components of the modular autonomous aircraft control and resupply station.

20. The modular autonomous aircraft control and resupply station of claim 19, wherein the enclosure comprises an intermodal shipping container configured according to at least one of ISO 668 and ISO 1496-1.
